(19) United States
(12) Patent Application Publication
(10) Pub. No.: US 2012/0322474 A1
(43) Pub. Date: Dec. 20, 2012

(54) Apparatus and Method for Communication

(75) Inventors: Matti MOISANEN, Oulu (FI); Petri PELKONEN, Oulu (FI); Samuli HEIKKINEN, Oulu (FI)

(73) Assignee: Renesas Mobile Corporation

(21) Appl. No.: 13/160,552

(22) Filed: Jun. 15, 2011

(51) Int. Cl. H04B 7/00

(52) U.S. Cl. 455/500

(57) ABSTRACT

Apparatus and method for communication are provided. The solution includes acquiring registration information on networks of more than one radio access technologies; selecting a radio access technology; and selecting on the basis of the selected radio access technology the network registration information to use when performing network selection.

### FIELD

The exemplary and non-limiting embodiments of the invention relate generally to wireless communication networks. Embodiments of the invention relate especially to an apparatus and a method in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

With the ever increasing demand for increasing data rates and higher quality services in the world of mobile communications comes ever increasing demand for better performance of cellular network infrastructures. New systems with new radio access technologies are being developed constantly. Likewise user equipment is developed to support multiple radio access technologies. The same equipment may be used to access different kinds of networks with different radio interfaces.

In current and future networks user equipment wishing to communicate with a network must perform a registration to the network. A registration is usually performed when user equipment is switched on or when user equipment recovers from a lack of coverage. In a given area there may be multiple networks with multiple radio access technologies present.

To perform a registration user equipment requires registration information of a network. Currently user equipment is configured to try registration using all access technologies it supports.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus in a communication system, comprising: at least one processor; and at least one memory including computer program code, the at least one memory and the computer program code configured to, with the at least one processor, cause the apparatus at least to perform: acquire registration information on networks of more than one radio access technologies; select a radio access technology; select on the basis of the selected radio access technology the network registration information to use when performing network selection.

According to another aspect of the present invention, there is provided a method in a communication system, comprising: acquiring registration information on networks of more than one radio access technologies; selecting a radio access technology; selecting on the basis of the selected radio access technology the network registration information to use when performing network selection.

According to another aspect of the present invention, there is provided a computer program product embodied on a distribution medium readable by a computer and comprising program instructions which, when loaded into an apparatus, execute a computer process comprising: acquiring registration information on networks of more than one radio access technologies; selecting a radio access technology; selecting on the basis of the selected radio access technology the network registration information to use when performing network selection.

### LIST OF DRAWINGS

Embodiments of the present invention are described below, by way of example only, with reference to the accompanying drawings, in which

FIG. 1 illustrates an example of a communication environment;

FIG. 2 is a flowchart illustrating an embodiment of the invention; and

FIG. 3 illustrates an example of an apparatus applying embodiments of the invention.

### DESCRIPTION OF SOME EMBODIMENTS

Embodiments are applicable to any base station, user equipment (UE), server, corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols and access networks to be used in communications systems exist and are under development. Some examples of different communication systems are global system for mobile communications (GSM), the universal mobile telecommunications system (UMTS) radio access network (UTRAN or E-UTRAN), long term evolution (LTE, known also as E-UTRA), long term evolution advanced (LTE-A), Wireless Local Area Network (WLAN) based on IEEE 802.11 standard, worldwide interoperability for microwave access (WiMAX), personal communications services (PCS) and systems using ultra-wideband (UWB) technology. IEEE refers to the Institute of Electrical and Electronics Engineers.

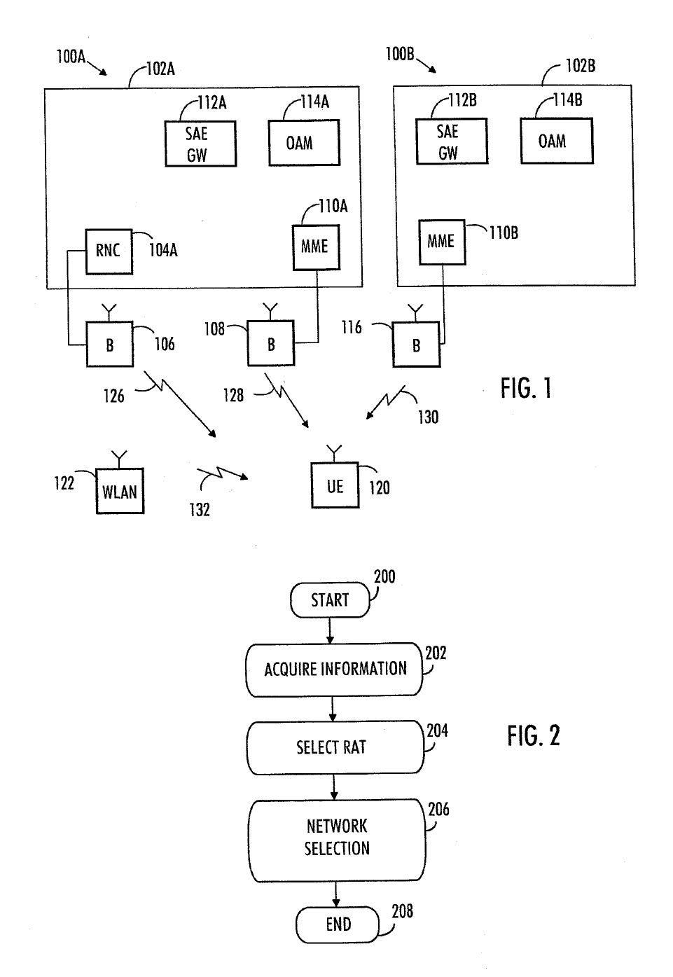

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

The example of FIG. 1 comprises two communication systems 100A, 100B of two operators. Each network comprises a core network 102A, 102B. In this example, system 100A comprises more than one radio access network of different radio access technologies (RAT). The system comprises a 3G based network comprising a Radio Network Controller RNC 104A and one or more base stations or NodeBs 106 connected to the RNC 104A. In addition, the system comprises an LTE or LTE-A based access network comprising eNodeB 108 connected to a MME (Mobility Management Entity) 110A of the core network 102A.

In this example, system 100B comprises an LTE or LTE-A based access network comprising eNodeB 116 connected to a MME (Mobility Management Entity) 110B of the core network 102B.

Each radio access technology network is defined by Public Land Mobile Network (PLMN) information. Typically each UE has a home PLMN, which is the network of the operator which subscriber the user of the UE is.

The core networks of the operators comprise following elements: an MME (Mobility Management Entity) 110A, 110B, an SAE GW (SAE Gateway) 112A, 112B and an OAM (Operations, Administration and Management system) 114A, 114B. It should be appreciated that a communication system may also comprise other core network elements besides the illustrated such as a Gateway Mobile Service Switching Centre, GMSC, a Serving GPRS Support Node, SGSN, for example. Furthermore, not all systems necessarily comprise all the above illustrated elements.

Base stations that may also be called eNodeBs (Enhanced node Bs) of a communication system may host the functions for Radio Resource Management Radio Bearer Control, Radio Admission Control, Connection Mobility Control, Dynamic Resource Allocation (scheduling). This applies to LTE or LTE-A based systems. For the 3G based systems the Radio Network Controller 104A may comprise some of the above mentioned functions. The MME 110A, 1108 is responsible for distributing paging messages to the eNodeBs. The SAE GW 112A, 112B is an entity configured to act as a gateway between the network and other parts of communication network such as the Internet for example. The SAE GW may be a combination of two gateways, a serving gateway (S-GW) and a packet data network gateway (P-GW).

In addition, FIG. 1 shows user equipment UE 120 in the service area of the base stations 106, 108 and 116.

FIG. 1 only illustrates a simplified example. In practice, networks may include more base stations and more cells may be formed by the base stations. The networks of two or more operators may overlap, the sizes and form of the cells may vary from what is depicted, etc.

The embodiments are not restricted to networks given above as an example, but a person skilled in the art may apply the solution to other communication networks provided with the necessary properties. For example, the connections between different network elements may be realized with Internet Protocol (IP) connections.

When the UE 120 is switched on or recovers from a lack of coverage it must perform a registration to a network in order to be able to communicate with the network.

FIG. 2 is a flowchart illustrating an embodiment of the invention. The embodiment starts at step 200.

In step 202, the UE 120 is switched on or it recovers from lack of coverage. It is configured to acquire registration information on networks of more than one radio access technologies. In an embodiment, the UE may acquire the information on the different PLMN's for example from a memory. Typically, UEs may store information on multiple PLMNs to which it has been registered. Information on registered PLMNs is access technology/domain specific and it is updated during access technology/domain specific location registration procedures. Registered PLMNs can be different from each other. For example, 3GPP specifications define separate storages (e.g. EF_{LOCI}, EF_{PSLOCI} and EF_{EPSLOCI} in universal subscriber identity module USIM) for different domains and access technologies for registration area information containing registered PLMN. The UE may read the PLMN information from the USIM. However any other method of storing and reading registered PLMN information can be applied in the scope of the embodiments of the invention.

In addition, the UE 120 may acquire PLMN information by receiving broadcast transmissions 126, 128, 130 from surrounding base stations. Base stations may be configured to transmit in system information on a broadcast channel available for UEs.

In an embodiment, the UE 120 may receive information on available RAT's using a wireless local area network (WLAN) connection 132 from a WLAN access point 122.

In an embodiment, the UE 120 may be configured to obtain information on the topology of the network or networks surrounding the UE. The UE may utilise information on network topology when selecting the network.

In an embodiment, the UE is configured to acquire information on the location of the apparatus, and utilise information on the location of the apparatus when selecting the network.

In step 204, the UE 120 is configured to select a radio access technology (RAT) with which it wishes to communicate. Typically the selection of which RAT to use is an operator specific parameter. In addition, the user of the UE may select a given RAT.

In step 206, the UE 120 is configured to select on the basis of the selected radio access technology the network registration information to use when performing a network selection. Thus, the registered PLMN to be used can be selected based on the currently selected access technology. As the UE typically comprises registration information on several PLMNs, the information to be used is selected on the basis of the selected access technology. For example, a PLMN selection from LTE utilizes LTE specific registration information.

The process ends in step 208.

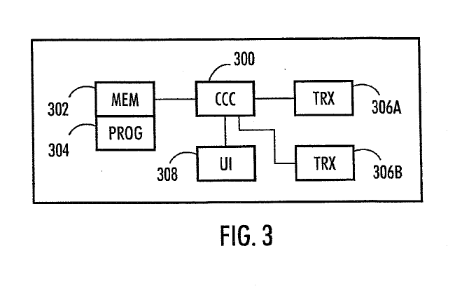

FIG. 3 illustrates an embodiment. The figure illustrates a simplified example of an apparatus applying embodiments of the invention. In some embodiments, the apparatus may be user equipment of a communications system.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus of the example includes a control circuitry 300 configured to control at least part of the operation of the apparatus.

The apparatus may comprise a memory 302 for storing data. Furthermore the memory may store software 304 executable by the control circuitry 300. The memory may be integrated in the control circuitry.

The apparatus comprises a first transceiver 306A. The first transceiver 306A is operationally connected to the control circuitry 300. It may be connected to an antenna arrangement (not shown). The first transceiver is configured to communicate with base stations of communication systems.

In an embodiment, the apparatus comprises a second transceiver 306B operationally connected to the control circuitry 300. It may be connected to an antenna arrangement (not shown). The second transceiver 306B may be configured to communicate with wireless local area networks. The first and second transceiver may be realized with a single transceiver.

The software 304 may comprise a computer program comprising program code means adapted to cause the control circuitry 300 of the apparatus to acquire registration information on networks of more than one radio access technologies, select a radio access technology and select on the basis of the selected radio access technology the network registration information to use when performing network selection.

The apparatus may further comprise user interface 308 operationally connected to the control circuitry 300. The user interface may comprise a display, a keyboard or keypad, a microphone and a speaker, for example. The display may be a touch sensitive display.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as technology advances, the inventive concept can be implemented in various ways. The invention and its embodiments are not limited to the examples described above but may vary within the scope of the claim.

1. An apparatus in a communication system, comprising:
at least one processor; and
at least one memory including computer program code,
the at least one memory and the computer program code configured to, with the at least one processor, cause the apparatus at least to perform:
acquire registration information on networks of more than one radio access technologies;
select a radio access technology;
select on the basis of the selected radio access technology the network registration information to use when performing network selection.

2. The apparatus of claim 1, the apparatus being configured to acquire registration information from universal subscriber identity module.

3. The apparatus of claim 1, the apparatus being configured to receive registration information from transmissions of base stations of available networks.

4. The apparatus of claim 1, the apparatus being configured to receive registration information from a wireless transmission.

5. The apparatus of claim 1, the apparatus being configured to utilise information on network topology when selecting the network registration information to use.

6. The apparatus of claim 1, the apparatus being configured to
acquire information on the location of the apparatus, and
utilise information on the location of the apparatus when selecting the network registration information to use.

7. The apparatus of claim 1, the apparatus being configured to acquire registration information from a memory.

8. A method in a communication system, comprising:
acquiring registration information on networks of more than one radio access technologies;
selecting a radio access technology;
selecting on the basis of the selected radio access technology the network registration information to use when performing network selection.

9. The method of claim 8, further comprising:
acquiring registration information from universal subscriber identity module.

10. The method of claim 8, further comprising: receiving registration information from transmissions of base stations of available networks.

11. The method of claim 8, further comprising: receiving registration information from a wireless transmission.

12. The method of claim 8, further comprising: utilising information on network topology when selecting the network registration information to use.

13. The method of claim 8, further comprising:
acquiring information on the location of the apparatus, and
utilising information on the location of the apparatus when selecting the network registration information to use.

14. The method of claim 8, further comprising:
acquiring registration information from a memory.

15. A computer program product embodied on a distribution medium readable by a computer and comprising program instructions which, when loaded into an apparatus, execute a computer process comprising:
acquiring registration information on networks of more than one radio access technologies;
selecting a radio access technology;
selecting on the basis of the selected radio access technology the network registration information to use when performing network selection.
